(19) United States
(12) Patent Application Publication
(10) Pub. No.: US 2010/0045618 A1
(43) Pub. Date: Feb. 25, 2010

(54) TOUCH-CONTROLLED ELECTRONIC APPARATUS WITH A BEND FORMING TOUCH PANEL

(76) Inventor: Hung-Ming Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/483,211

(22) Filed: Jun. 11, 2009

(30) Foreign Application Priority Data
Aug. 20, 2008 (TW) 097214932

(51) Int. Cl. G06F 3/041

(52) U.S. Cl. 345/173

(57) ABSTRACT

A touch-controlled electronic apparatus includes a housing whereon a transparent region and an opaque region are formed, and a touch panel. The touch panel includes a sensing region disposed on a side of the transparent region, and a non-sensing region disposed on a side of the opaque region and formed outside the sensing region in a bend forming manner. The touch-controlled electronic apparatus further includes an adhesive layer disposed between the housing and the touch panel for gluing the touch panel and the housing. An outer side of the adhesive layer is disposed between the housing and the non-sensing region of the touch panel in a bend forming manner.

### BACKGROUND OF THE INVENTION

1. Field of the Invention

The present invention relates to a touch-controlled electronic apparatus, and more particularly, to a touch-controlled electronic apparatus with a bend forming touch panel.

2. Description of the Prior Art

Currently, in the market of various kinds of consumer electronic products, touch panels have been widely applied in portable electronic devices such as personal digital assistants (PDA), mobile Phones, and notebooks for serving as the interface of information communication tool between the users and the electronic devices. Since modern electronic products increasingly become smaller, thinner, and lighter, the display device with a touch panel has gradually become the key component of various electronic products in order to save space and to replace traditional input apparatuses, such as operation buttons, keyboard, and mouse, leaning on the trend of requirement of human-based designed flat computer. There are many kinds of touch panels with different technology, such as a capacitive touch panel, a resistance touch panel, an ultrasonic touch panel, or infrared touch panel, for utilizing in many different fields. For example, the capacitive touch panel detects capacity change due to electrostatic induction of human finger for achieving the touch-sensing function, and it is applied for consumer products, ATM, KIOSK, or other industrial instruments.

Please refer to FIG. 1. FIG. 1 is a sectional view of a touch-controlled electronic apparatus 10 in the prior art. The touch-controlled electronic apparatus 10 includes a housing 12 made of non-conducting material, such as plastic material. A transparent region 121 and an opaque region 122 are formed on the housing 12. The transparent region 121 and the opaque region 122 can be connected with double injection molding technology. The transparent region 121 of the housing 12 can be made of light pervious material, and the opaque region 122 of the housing 12 can be made of light tight material. A width of the housing is D1, and a width of the transparent region 121 of the housing 12 is D1′. The touch-controlled electronic apparatus 10 further includes a touch panel 14 installed inside the housing 12. The touch panel 14 can be a capacitive touch. Please refer to FIG. 2. FIG. 2 is a diagram of the touch panel 14 in the prior art. The touch panel 14 includes a sensing region 141, and a non-sensing region 142. The sensing region 141 is an active region for achieving the touch-sensing function by detecting capacity change due to electrostatic induction of human finger. The non-sensing region 142 is disposed outside the sensing region 141. For example, the non-sensing region 142 can be disposed on a single side or a plurality of sides of the sensing region 141. The non-sensing region 142 of the touch panel 14 can be a wiring region for transmitting touch signals to a processor inside the touch-controlled electronic apparatus 10 (not shown in figures). That is, the non-sensing region 142 is a void region of the touch panel 14. An area of the sensing region 141 of the touch panel 14 is larger than an area of the transparent region 121 of the housing 12. The opaque region 122 of the housing 12 covers the sensing region 141 of the touch panel 14 partly, and the opaque region 122 of the housing 12 covers the non-sensing region 142 of the touch panel 14 completely so as to avoid void touching action.

The touch-controlled electronic apparatus 10 further includes an adhesive layer 16 disposed between the housing 12 and the touch panel 14 for gluing the touch panel 14 and the housing 12 so as to fix the touch panel 14 on an inner side of the housing 12. The touch-controlled electronic apparatus 10 further includes a display panel 18 disposed below the touch panel 14 for displaying image data. The touch-controlled electronic apparatus 10 further includes a buffer layer 20 disposed between the touch panel 14 and the display panel 18 for acting as a cushion. The buffer layer 20 can be a gasket or made of sponge or adhesive material. As shown in FIG. 1, in general, the touch panel 14 can be adhered to the inner side of the housing 12 planarly. The opaque region 122 of the housing 12 covers the sensing region 141 of the touch panel 14 partly and covers the non-sensing region 142 of the touch panel 14 completely, so the housing 12 has to be wider than a part of the sensing region 141 and the whole non-sensing region 142 covered by the opaque region 122 resulting in limitation of mechanical design of the touch-controlled electronic apparatus 10, such as enlarging the size of the touch-controlled electronic apparatus 10.

### SUMMARY OF THE INVENTION

According to the claimed invention, a touch-controlled electronic apparatus includes a housing whereon a transparent region and an opaque region are formed, and a touch panel. The touch panel includes a sensing region disposed on a side of the transparent region, and a non-sensing region disposed on a side of the opaque region and formed outside the sensing region in a bend forming manner. The touch-controlled electronic apparatus further includes an adhesive layer disposed between the housing and the touch panel for gluing the touch panel and the housing. An outer side of the adhesive layer is disposed between the housing and the non-sensing region of the touch panel in a bend forming manner.

According to the claimed invention, the transparent region and the opaque region are connected with double injection molding technology.

According to the claimed invention, the housing is made of non-conducting material.

According to the claimed invention, an area of the sensing region is greater than an area of the transparent region, and the opaque region on the housing covers the sensing region partially.

According to the claimed invention, the opaque region on the housing covers the non-sensing region completely.

According to the claimed invention, the non-sensing region is disposed on a single side of the sensing region.

According to the claimed invention, the non-sensing region is disposed on a plurality of sides of the sensing region.

According to the claimed invention, the opaque region on the housing is bent at a bending angle, and a bending angle of the non-sensing region and a bending angle of the outer side of the adhesive layer are equal to the bending angle of the opaque region substantially.

According to the claimed invention, the non-sensing region of the touch panel is a wiring region.

According to the claimed invention, the touch-controlled electronic apparatus further includes a display panel disposed below the touch panel.

According to the claimed invention, the touch-controlled electronic apparatus further includes a buffer layer disposed between the touch panel and the display panel.

According to the claimed invention, the buffer layer is made of sponge material.

According to the claimed invention, the buffer layer is made of adhesive material.

According to the claimed invention, the touch panel is a capacitive touch panel.

According to the claimed invention, the non-sensing region is disposed on the side of the opaque region and formed outside the sensing region in a heat bend forming manner.

According to the claimed invention, the outer side of the adhesive layer is disposed between the housing and the non-sensing region of the touch panel in a heat bend forming manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view of a touch-controlled electronic apparatus in the prior art.

FIG. 2 is a diagram of a touch panel in the prior art.

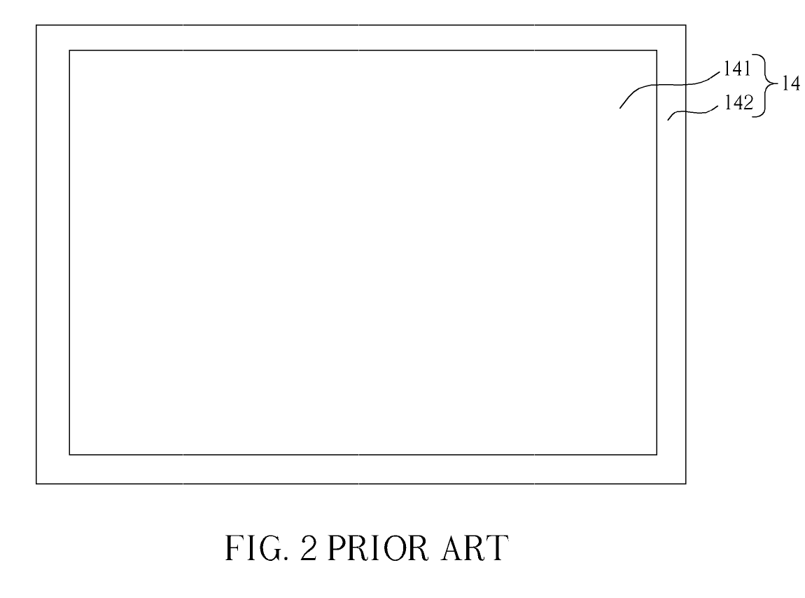

FIG. 3 is a sectional view of a touch-controlled electronic apparatus according to a preferred embodiment of the present invention.

FIG. 4 is a diagram of a touch panel according to the preferred embodiment of the present invention.

FIG. 5 is a sectional view of a touch-controlled electronic apparatus according to another embodiment of the present invention.

### DETAILED DESCRIPTION

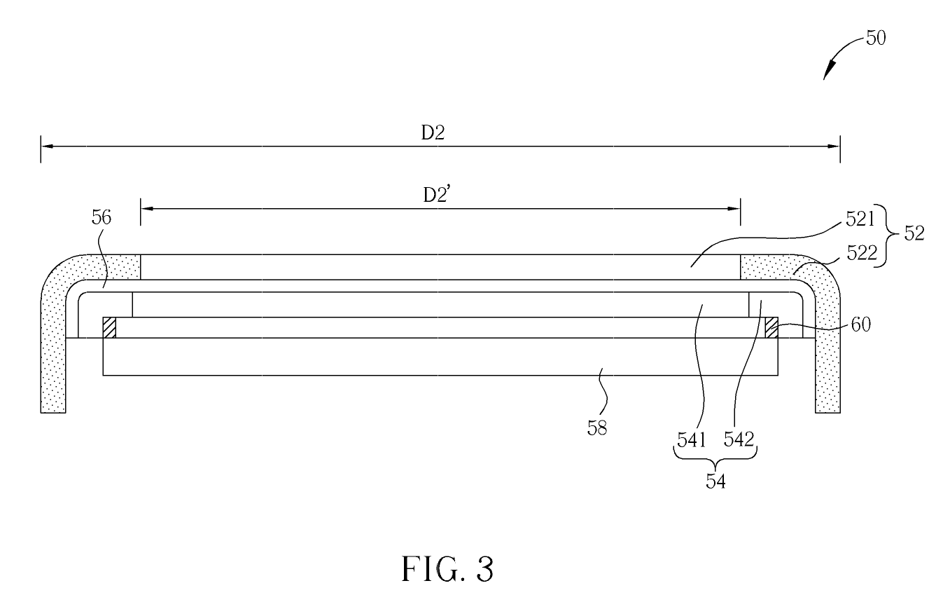

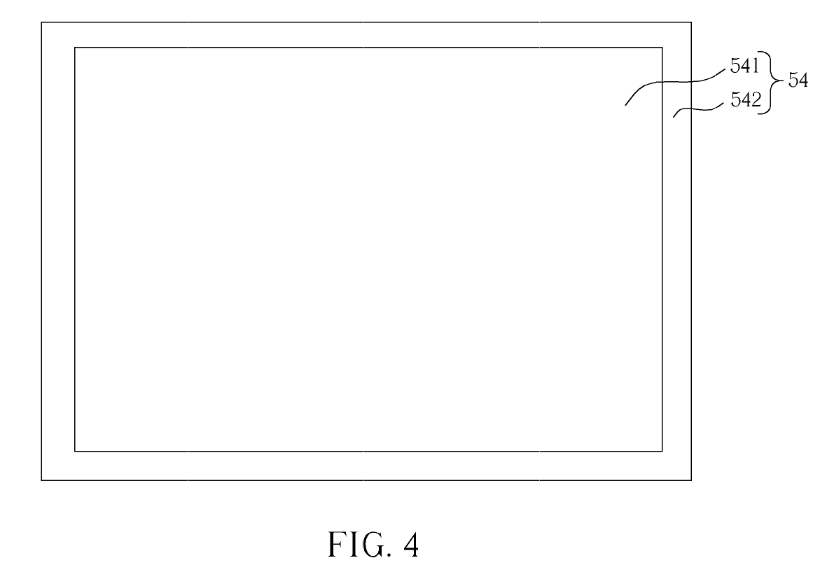

Please refer to FIG. 3. FIG. 3 is a sectional view of a touch-controlled electronic apparatus 50 according to a preferred embodiment of the present invention. The touch-controlled electronic apparatus 50 includes a housing 52 made of non-conducting material, such as plastic material. A transparent region 521 and an opaque region 522 are formed on the housing 52. The transparent region 521 and the opaque region 522 can be connected with double injection molding technology. The transparent region 521 of the housing 52 can be made of light pervious material, and the opaque region 522 of the housing 52 can be made of light tight material. A width of the housing is D2, and a width of the transparent region 521 of the housing 52 is D2′. The touch-controlled electronic apparatus 50 further includes a touch panel 54 installed inside the housing 52. The touch panel 54 can be a capacitive touch. Please refer to FIG. 4. FIG. 4 is a diagram of the touch panel 54 according to the preferred embodiment of the present invention. The touch panel 54 includes a sensing region 541, and a non-sensing region 542. The sensing region 541 is an active region for achieving the touch-sensing function by detecting capacity change due to electrostatic induction of human finger. The non-sensing region 542 is disposed outside the sensing region 541. For example, the non-sensing region 542 can be disposed on a single side or a plurality of sides of the sensing region 541. The non-sensing region 542 of the touch panel 54 can be a wiring region for transmitting touch signals to a processor inside the touch-controlled electronic apparatus 50 (not shown in figures). That is, the non-sensing region 542 is a void region of the touch panel 54. An area of the sensing region 541 of the touch panel 54 is larger than an area of the transparent region 521 of the housing 52. The opaque region 522 of the housing 52 covers the sensing region 541 of the touch panel 54 partly, and the opaque region 522 of the housing 52 covers the non-sensing region 542 of the touch panel 54 completely so as to avoid void touching action.

The touch-controlled electronic apparatus 50 further includes an adhesive layer 56 disposed between the housing 52 and the touch panel 54 for gluing the touch panel 54 and the housing 52 so as to fix the touch panel 54 on an inner side of the housing 52. The touch-controlled electronic apparatus 50 further includes a display panel 58 disposed below the touch panel 54 for displaying image data. The touch-controlled electronic apparatus 50 further includes a buffer layer 60 disposed between the touch panel 54 and the display panel 58 for acting as a cushion. The buffer layer 60 can be a gasket or made of sponge or adhesive material.

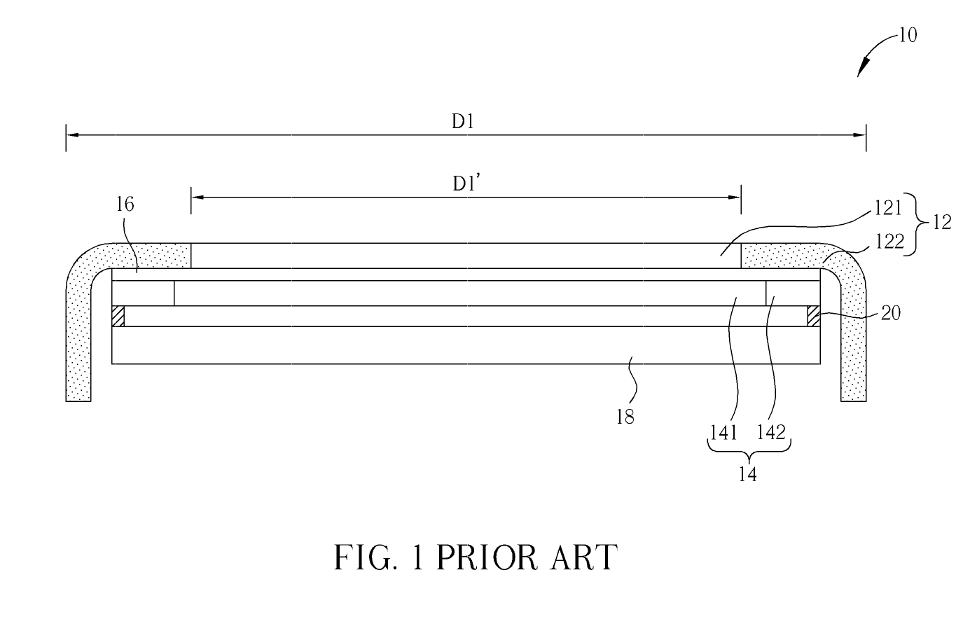

As shown in FIG. 3, the characteristic of the present invention is that the non-sensing region 542 of the touch panel 54 is disposed on a side of the opaque region 522 of the housing 52 and formed outside the sensing region 541 in a bend forming manner, and an outer side of the adhesive layer 56 is disposed between the housing 52 and the non-sensing region 542 of the touch panel 54 in a bend forming manner. The bend forming manner can be a heat bend forming manner or other forming manner. The non-sensing region 542 of the touch panel 54 and the outer side of the adhesive layer 56 can be bent first and then be adhered to each other, or the non-sensing region 542 of the touch panel 54 and the outer side of the adhesive layer 56 can be adhered to each other first and then be bent together. In addition, a bending angle of the opaque region 522 of the housing 52, a bending angle of the non-sensing region 542 of the touch panel 54, and a bending angle of the outer side of the adhesive layer 56 can be the same substantially so that the touch panel 54 can be adhered to the inner side of the housing 52 via the adhesive layer 56 tightly without any gap. The touch panel 54 is not adhered to the inner side of the housing 52 planarly. That is, the non-sensing region 542 of the touch panel 54 and the outer side of the adhesive layer 56 combine with the housing 52 with curvature. There is no need to reserve more space on the housing 52 for adhesion of the outer side of the adhesive layer 56, and the non-sensing region 542 of the touch panel 54 can be hidden on a lateral side of the housing 52 so as to increase flexibility of mechanical design of the touch-controlled electronic apparatus 50. As shown in FIG. 1 and FIG. 1, if the width D1 of the housing 12 of the conventional touch-controlled electronic apparatus 10 is equal to the width D2 of the housing 52 of the touch-controlled electronic apparatus 50 of the present invention, that is, the outward size of the conventional touch-controlled electronic apparatus 10 is the same as the outward size of the touch-controlled electronic apparatus 50 of the present invention, the width D2′ of the transparent region 521 of the housing 52 of the touch-controlled electronic apparatus 50 of the present invention is greater than the width D1′ of the transparent region 121 of the housing 12 of the conventional touch-controlled electronic apparatus 10. This is because the part touch panel 54 and the part adhesive layer 56 combine with the housing 52 with curvature in the bend forming manner so that the non-sensing region 542 of the touch panel 54 can be hidden on the lateral side of the housing 52 for enlarging the range of the transparent region 521 of the housing 52. In conclusion, in presupposition of the touch-controlled electronic apparatus of the same size, the present invention can utilize larger touch panel or the touch panel with larger sensing region. That is, the present invention can increase the sensing range of the touch panel without increasing the size of the touch-controlled electronic apparatus.

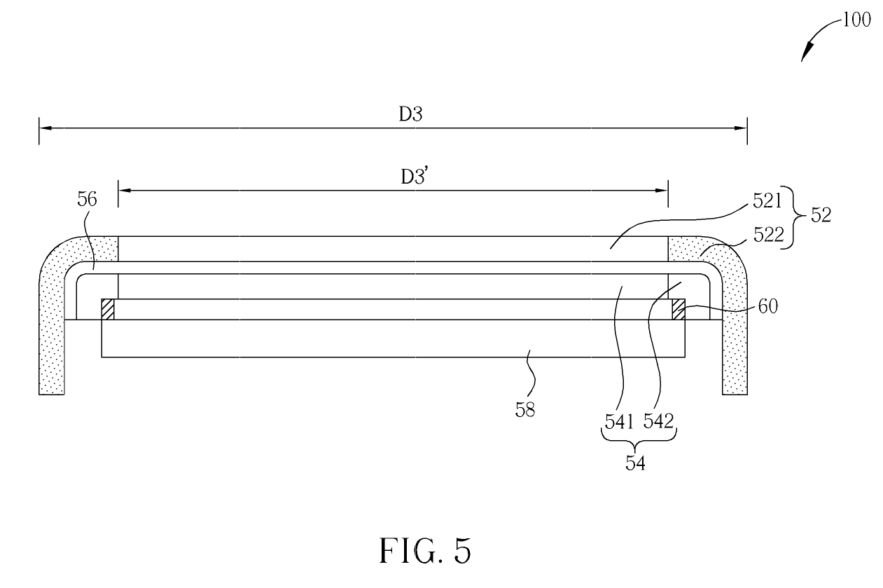

Please refer to FIG. 5. FIG. 5 is a sectional view of a touch-controlled electronic apparatus 100 according to another embodiment of the present invention. Please note that elements with the same reference numerals are substantially the same through the various embodiments. As shown in FIG. 1 and FIG. 5, if the width D1′ of the transparent region 121 of the housing 12 of the conventional touch-controlled electronic apparatus 10 is equal to the width D3′ of the transparent region 521 of the housing 52 of the touch-controlled electronic apparatus 50 of the present invention, that is, the visible range and the available sensing region of the conventional touch-controlled electronic apparatus 10 are the same as the visible range and the available sensing region of the touch-controlled electronic apparatus 100 of the present invention, the width D3 of the housing 52 of the touch-controlled electronic apparatus 100 of the present invention is less than the width D1 of the housing 12 of the conventional touch-controlled electronic apparatus 10. This is because the part touch panel 54 and the part adhesive layer 56 combine with the housing 52 with curvature in the bend forming manner so that the non-sensing region 542 of the touch panel 54 can be hidden on the lateral side of the housing 52 for enlarging the range of the transparent region 521 of the housing 52. In conclusion, in presupposition of the touch-controlled electronic apparatus of the same size (the same visible range or the same sensing region), the present invention can minimize the size of the touch-controlled electronic apparatus due to reduction of the occupying space of the touch panel so as to utilize mechanical space effectively.

In contrast to the prior art, the present invention utilizes mechanical design that the non-sensing region of the touch panel and the outer side of the adhesive layer combine with the housing with curvature in the bend forming manner so that the non-sensing region of the touch panel can be hidden on the lateral side of the housing for reducing the occupying space of the touch panel. The present invention can increase flexibility of mechanical design of the touch-controlled electronic apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch-controlled electronic apparatus comprising:
a housing whereon a transparent region and an opaque region are formed;
a touch panel comprising:
a sensing region disposed on a side of the transparent region; and
a non-sensing region disposed on a side of the opaque region and formed outside the sensing region in a bend forming manner; and
an adhesive layer disposed between the housing and the touch panel for gluing the touch panel and the housing, an outer side of the adhesive layer being disposed between the housing and the non-sensing region of the touch panel in a bend forming manner.

2. The touch-controlled electronic apparatus of claim 1 wherein the transparent region and the opaque region are connected with double injection molding technology.

3. The touch-controlled electronic apparatus of claim 1 wherein the housing is made of non-conducting material.

4. The touch-controlled electronic apparatus of claim 1 wherein an area of the sensing region is greater than an area of the transparent region, and the opaque region on the housing covers the sensing region partially.

5. The touch-controlled electronic apparatus of claim 1 wherein the opaque region on the housing covers the non-sensing region completely.

6. The touch-controlled electronic apparatus of claim 1 wherein the non-sensing region is disposed on a single side of the sensing region.

7. The touch-controlled electronic apparatus of claim 1 wherein the non-sensing region is disposed on a plurality of sides of the sensing region.

8. The touch-controlled electronic apparatus of claim 1 wherein the opaque region on the housing is bent at a bending angle, and a bending angle of the non-sensing region and a bending angle of the outer side of the adhesive layer are equal to the bending angle of the opaque region substantially.

9. The touch-controlled electronic apparatus of claim 1 wherein the non-sensing region of the touch panel is a wiring region.

10. The touch-controlled electronic apparatus of claim 1 further comprising a display panel disposed below the touch panel.

11. The touch-controlled electronic apparatus of claim 10 further comprising a buffer layer disposed between the touch panel and the display panel.

12. The touch-controlled electronic apparatus of claim 11 wherein the buffer layer is made of sponge material.

13. The touch-controlled electronic apparatus of claim 11 wherein the buffer layer is made of adhesive material.

14. The touch-controlled electronic apparatus of claim 1 wherein the touch panel is a capacitive touch panel.

15. The touch-controlled electronic apparatus of claim 1 wherein the non-sensing region is disposed on the side of the opaque region and formed outside the sensing region in a heat bend forming manner.

16. The touch-controlled electronic apparatus of claim 1 wherein the outer side of the adhesive layer is disposed between the housing and the non-sensing region of the touch panel in a heat bend forming manner.
